(19) United States
(12) Patent Application Publication
(10) Pub. No.: US 2020/0349623 A1
(43) Pub. Date: Nov. 5, 2020

(54) System and Method of Searching for and Engaging Service Provider

(71) Applicant: ZINKN INC., Sun City, AZ (US)

(72) Inventor: Michael T. Vogler, Sun City, AZ (US)

(73) Assignee: ZINKN INC., Sun City, AZ (US)

(21) Appl. No.: 16/401,113

(22) Filed: May 1, 2019

(51) Int. Cl. G06Q 30/06; G06Q 20/16; G06Q 30/02

(52) U.S. Cl. CPC G06Q 30/0613; G06Q 30/0203; G06Q 30/0641; G06Q 20/16

(57) ABSTRACT

An electronic network is provided to facilitate a service transaction. A database provides a data structure to organize records for the service transaction. A service request from a service requester is posted and a service provider with capabilities to perform the service request from the first computing system is dispatched by an electronic service agent to perform the service transaction. The service provider can be a preferred service provider. The electronic service agent searches for a service provider with capabilities to perform the service request. The service provider is forwarded to the service requester for the service requester to accept the service provider for the service request. The service requester provides feedback for the service provider. The service provider provides feedback for the service requester. The service provider can be tracked during the service transaction. The service provider is compensated after performing the service transaction.

### FIELD OF THE INVENTION

The present invention relates in general to an enhanced computer system and, more particularly, to a system and method of searching for and engaging a service provider.

### BACKGROUND OF THE INVENTION

A computer system provides an opportunity to find and engage in personal and professional connections and share and exchange information. People routinely need personal and professional services and turn to computer technology to find a service provider with relevant and beneficial experience, capabilities, availability, pricing, reviews, and alternatives. A computer system provides an opportunity to share and exchange information about service providers. The availability and access to connections and information continue to expand with higher bandwidth internet, more storage space, mobile devices, and faster computing platforms.

Consider a situation where a user needs a service, e.g., transportation to a doctor appointment, daycare for child or elderly person, home repair, or personal assistant. The user may conduct an internet search, often many repeated internet searches, to find a service provider. A competent, reliable, cost effective service provider can be difficult to find. The user parses through options, interviews candidates, reads reviews and feedback, if still unconvinced as to a good service provider, conducts more internet searching.

Computer technology itself does not necessarily or inherently solve the problem. In fact, the vast amounts of information and resources available with computer search tools and electronic communication links to almost every information source out there can make the simplest of tasks quite complex. Users must still navigate through many options and potential service providers to find someone that meets their needs. If a previous internet search does not yield an acceptable service provider, then additional searches are typically performed before a decision can be made for a particular service provider. Again, much computing time and resources can be wasted in trying to match the right service provider with the right customer, which is why the problem is specific to the realm of computer networks and computer technology. Many repeat searches are conducted and offers are made to hit the decision threshold to select a service provider. The adhoc approach to the information searching places a burden on the computer systems. The information is disorganized, inaccurate, and does not permit efficient operation of the computer systems. The computer system does not function in an optimal manner relative to searching for and engaging a service provider. The computer network utilization tends to suffer, particularly with a large population doing the same inefficient and repetitive searching and evaluation of service providers.

### BRIEF DESCRIPTION OF THE DRAWINGS

FIG. 1 illustrates an electronic service agent handling service between service requesters and service providers;

FIG. 2 illustrates a data structure for the service transaction;

FIG. 3 illustrates an electronic communication network connecting users and devices;

FIG. 4 illustrates computer systems operating on the electronic communication network;

FIGS. 5a-5b illustrate an account and profile webpage or app screen for users to set up with the service agent;

FIG. 6 illustrates a home webpage or app screen for the service agent with first level features;

FIG. 7 illustrates a request for service with the service agent;

FIG. 8 illustrates a map for tracking the service provider;

FIG. 9 illustrates a flowchart of a service transaction;

FIG. 10 illustrates a profile of the service provider responding to the service request;

FIG. 11 illustrates a timer to track a length of the service;

FIGS. 12a-12b illustrate feedback about the service provider and service requester; and

FIGS. 13a-13b illustrate a preferred service provider.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

People routinely need personal and professional services and turn to computer technology to find a service provider with relevant and beneficial experience, capabilities, availability, pricing, reviews, and alternatives. A computer system provides an opportunity to share and exchange information about service providers. The availability and access to connections and information continue to expand with higher bandwidth internet, more storage space, mobile devices, and faster computing platforms. Consider a situation where a user needs a service, e.g., transportation to a doctor appointment, caregiver for child or elderly person, personal assistant, home repair, or helper for a time when an otherwise able-bodied adult is temporarily disabled or a person needs a helping hand. The service may be needed realtime and on demand. The user may conduct an internet search, often many repeated internet searches, to find a service provider. A competent, reliable, cost effective service provider can be difficult to find. The user parses through options, interviews candidates, reads reviews and feedback, if still unconvinced as to a good service provider, conducts more internet searching. However, as discussed in the background, the adhoc approach to the information searching places a burden on the computer systems. The information is disorganized, inaccurate, and does not permit efficient operation of the computer systems. The computer system does not function in an optimal manner relative to searching for and engaging a service provider.

An enhanced computer system with associated data and organizational structures would monitor and regulate the connection between users seeking to request and provide services. The requesting user would ask for direct and specific services. The service provider would have relevant skills, knowledge, and experience. The service provider is compensated, with historical and objective feedback on the individual performing the services, so there is an expectation or accountability for the services.

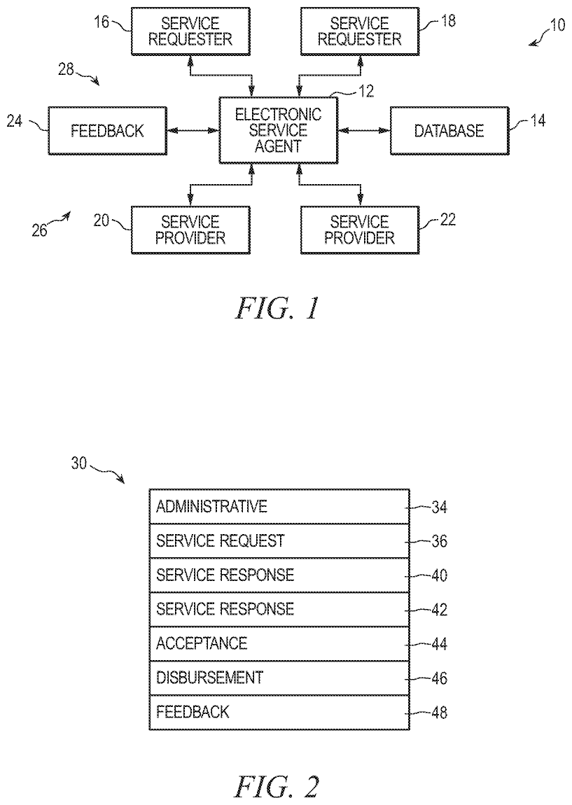

FIG. 1 shows enhanced computer system 10 with electronic service agent 12 maintaining database 14. Database 14 is a mass storage system, e.g., server mass storage, with a data structure and record organization optimized for a service transaction between users. Service requesters 16 and 18 are users with a request or inquiry for service made to electronic service agent 12. Service requester 16 or 18 makes a request for someone with skills and knowledge for a particular service. Service provider 20 is a person with the specific skills, knowledge, and experience relevant to the service or inquiry proposed by service requester 16. Likewise, service provider 22 is another person with the specific skills, knowledge, and experience relevant to the service or inquiry proposed by service requester 16 or 18. For example, service requester 16 or 18 requests a service provider to provide transportation to a medical appointment, or temporary care for a child or family pet. Service provider 20 or 22 responds that he or she is available to provide the requested service. Electronic service agent 12 functions as an organizer and facilitator between service requester 16 or 18 and service provider 20 or 22 (collectively users 26) to post, respond, accept, disbursement, and record feedback for the service transaction using database 14 and feedback block 24 on electronic service platform 28 executing on computer system 10.

Electronic service agent 12 maintains unique data structure 30 in database 14, as shown in FIG. 2, to facilitate and optimize the service transaction between users 26 to enhance the function, operation, and efficiency of computer system 10. There can be one or more data records in data structure 30 per service transaction. Multiple exchanges between users 26 can create multiple data records in data structure 30. For example, a first service request results in a first service response and first data record, a second service request results in a second service response and second data record, and so on.

Data structure 30 includes an administrative record 34 for tracking information related to users 26, such as name, address, email, phone, skills, expertise, and bank account. Request record 36 includes general subject matter, content of the request, time and date of submission, timeframe of service response, confidentiality, additional considerations, and revision number. Service response record 40-42 each include content of the service response, time and date of submission, conditional statements, qualifying statements, and revision number. Service response record 40-42 may be two separate service responses from one service provider 20, or service responses from each of two service providers 20-22. Acceptance record 44 includes time and date of acceptance by service requester, confirmation of service provider qualifications, conditional statements, and confirmation to disburse. Disbursement record 46 includes amount of disbursement, date of disbursement, disbursement source or institution, confirmation of requirements and conditions for disbursement, and administrative fees. Feedback record 48 includes feedback made by the service requester relevant to the performance of the service provider and quality, accuracy, and usefulness of the service response. Feedback record 48 can be a Likert scale of fixed assessments and comment section for the service requester, as well as a confirmation or rebuttal section for the service provider.

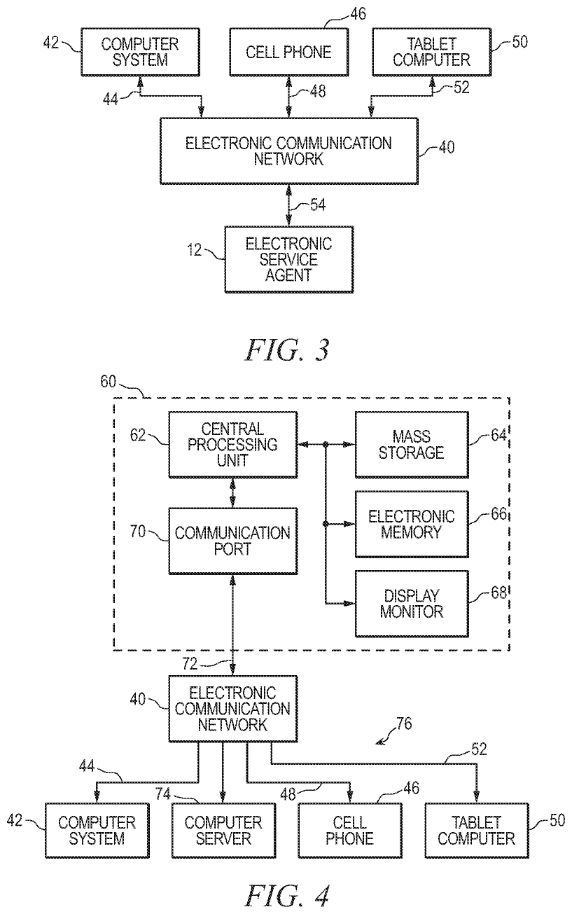

FIG. 3 shows an electronic communication network 40 for transmitting information between users 26 using one or more of computer system 42, cell phone 46, or tablet computer 50 to access electronic service agent 12. Computer system 42 is connected to electronic communication network 40 by way of communication channel or link 44. Likewise, cellular telephone or smartphone 46 connects to electronic communication network 40 via communication link 48 and tablet computer 50 is connected to electronic communication network 40 by way of communication channel or link 52. Service agent 12 operating on a computer server communicates with electronic communication network 40 over communication channel or link 54.

The electronic communication network 40 is a distributed network of interconnected routers, gateways, switches, and servers, each with a unique internet protocol (IP) address to enable communication between individual computers, cellular telephones, tablets, electronic devices, or nodes within the network. In one embodiment, communication network 40 is a global, open-architecture network, commonly known as the internet. In other embodiments, electronic communication network 40 includes a cell phone service network. Communication channels 44, 48, 52, and 54 are bi-directional and transmit data between computer system 42, cell phone 46, tablet computer 50, service agent 12, and electronic communication network 40 in a hard-wired or wireless configuration. For example, computer system 42 has email, audio/video, and web browsing capability, and consumer cell phone 46 and tablet computer 50 have email, mobile applications (apps), audio/video, texting, and web browsing capability.

Further detail of the computer systems used in electronic communication network 40 is shown in FIG. 4 as a simplified computer system 60 for executing software programs used in the electronic communication process. Computer system 60 is a general-purpose computer including a central processing unit (CPU) or microprocessor 62, mass storage device or hard disk 64, electronic memory or RAM 66, display monitor 68, and communication port 70. Data records in data structure 30 can be stored in mass storage device 64 and/or electronic memory 66 and organized to facilitate and optimize the service transaction between users 26 and enhance the functionality, operation, and efficiency of computer system 10. Communication port 70 represents a modem, high-speed Ethernet link, wireless, or other electronic connection to transmit and receive data over communication link 72 to electronic communication network 40. Computer system 42 and computer server 74 are configured similar to, and include similar internal components as, computer 60. Cell phone 46 and tablet 50 include related components as computer system 60, although commonly run different operating systems, software, and include smaller parts and packaging. Computer systems 42 and 60, computer server 74, cell phone 46, and tablet computer 50 (collectively referenced as devices 76) transmit and receive information and data over electronic communication network 40.

Devices 76 are physically located in any location with access to a modem or communication link to network 40. For example, devices 76 are located in a home or business office, a facility of service agent 12, or are mobile and accompany the user to any convenient location, e.g., remote offices, consumer locations, hotel rooms, residences, vehicles, public places, or other locales with wired or wireless access to electronic communication network 40. Some devices 76 are carried with the individuals and operate with mobile apps.

Devices 76 run application software and computer programs, which are used to display user interface screens, execute the functionality, and provide the electronic communication features as described herein. The application software includes an internet browser, local email application, mobile apps, word processor, spreadsheet, audio/video feature, application programming interface (API), and the like. In one embodiment, the screens and functionality come from the application software, i.e., the electronic communication runs directly on devices 76. Alternatively, the screens and functions are provided remotely from one or more websites and webpages or app screens on servers connected to electronic communication network 40.

In one embodiment, electronic service agent 12 includes an API accessed by users 26. Users 26 enter data directly using the API, or through websites and applications connected to electronic service agent 12 via the API. An API facilitates the request and retrieval of information on behalf of a software program or application. An API is a set of commands, functions, and protocols, which programmers or developers use when building software for a specific operating system or application. An API allows programmers to use predefined functions to interact with an external application or computer system.

An API allows a software application to communicate with other applications running on a remote server over the internet using a series of API calls. With APIs, calls back and forth between applications are managed through web services. Web services are a collection of technological standards and protocols, including XML (Extensible Markup Language), a programming language by which applications communicate over the internet. An API call can comprise software code written as a series of XML messages. Each XML message corresponds to a different function of the remote service. For example, in a conferencing API, there are XML messages that correspond to each element required to schedule a new Web conference. Those elements include the conference time, the organizer's name and contact information, the invitees, and the duration of the conference.

By providing a means for requesting program services, an API can grant access to or open an application as an interface, defining the way in which separate entities or applications communicate. In some cases, software developers analogize APIs as “doors”, or “gateways,” that enable communication between different applications. APIs provide flexible yet controlled access to the data of an external computer system. The value of existing programs can be multiplied because content of the existing applications can be re-used, accessed, or exploited using APIs. Users 26 communicate with a web browser plugin connected to electronic service agent 12 via an API to allow interaction between the users.

The software is originally provided on computer readable media, such as compact disks (CDs), digital versatile disks (DVDs), flash drives, and other optical media or mass storage medium. Alternatively, the software is downloaded electronically, such as from a host or vendor website or app store. The software is installed onto the computer system mass storage 64 and/or electronic memory 66, and is accessed and controlled by the computer operating system. Software updates are also available on mass storage medium or downloadable from the host or vendor website. The software, as provided on the computer readable media or downloaded from electronic links, represents a computer program product containing computer readable program code embodied in a non-transitory computer program medium. Devices 76 execute instructions of the application software utilizing data structure 30 for communication between users 26 and electronic service agent 12 to enable and administrate the service transaction. Cell phone 46 or tablet computer 50 runs one or more mobile apps to execute instructions for communication between users 26 and electronic service agent 12, which enables and administrates the service transaction. The application software is an integral part of the control of electronic service activity within enhanced computer system 10.

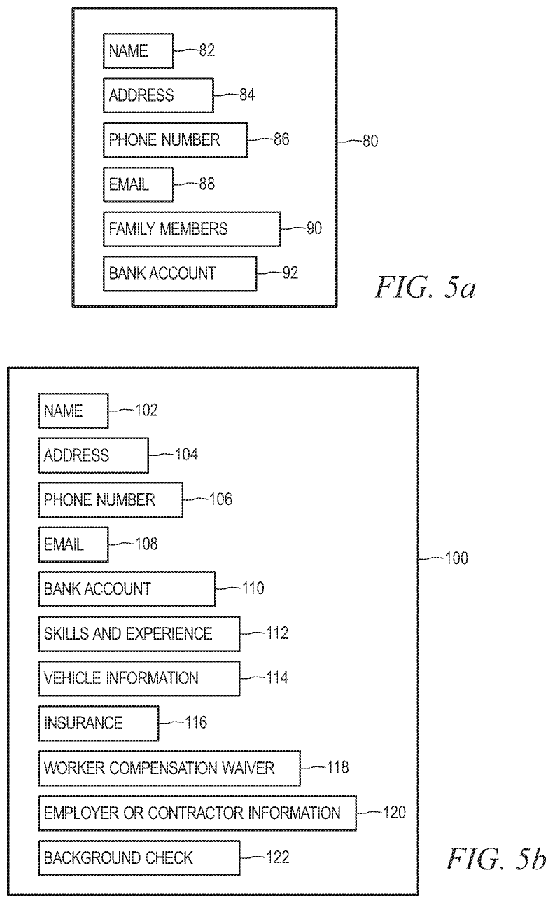

To interact with electronic service agent 12, user 26 creates an account and profile with the service agent. Full access requires completion of a registration process. User 26 typically downloads the app onto smartphone 46, or website on computer 42, and follows the installation and setup wizard. Service requester 16-18 accesses webpage or app screen 80 operated by service agent 12 on electronic service platform 28 and provides data to complete the registration and activation process, as shown in FIG. 5a. The data provided by service requester 16-18 to electronic service agent 12 includes name in block 82, address in block 84, phone number in block 86, email address in block 88, family members in block 90, and bank account/credit card in block 92, and other information and credentials, such as gender, date of birth, occupation, photo, and authorization to access location of service requester 16-18, necessary to establish a profile and identity for the user. Each user 26 (family member, child, elderly parent, adult, business, hostess, delivery) would have a unique profile. The service requester agrees to the terms and conditions of conducting electronic communication through service agent 12.

Service provider 20-22 accesses webpage or app screen 100 operated by service agent 12 on electronic service platform 28 and provides data to complete the registration and activation process, as shown in FIG. 5b. The data provided by service provider 20-22 to electronic service agent 12 includes name in block 102, address in block 104, phone number in block 106, email address in block 108, bank account in block 110, skills and experience in block 112, vehicle information in block 114, insurance in block 116, worker compensation waiver in block 118, employer or contractor information in block 120, background check in block 122, and other information and credentials, such as gender, date of birth, photo, occupation, education, and authorization to access location of service provider 20-22, necessary to establish a profile and identity for the user. The service provider agrees to the terms and conditions of conducting electronic communication through service agent 12.

The user's profile is stored and maintained within database 14. User 26 can access and update his or her profile or interact with electronic service agent 12. The user's profile and personal data remains secure and, where appropriate, confidential within electronic service agent 12.

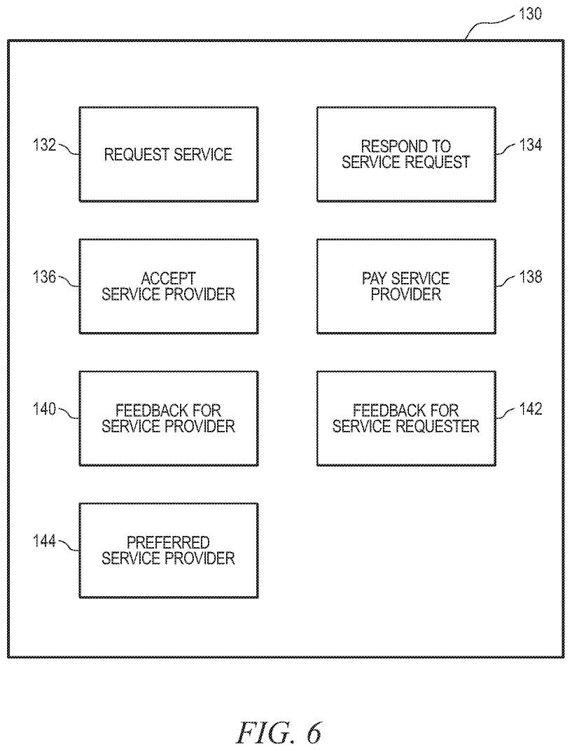

Once user 26 has logged-in to electronic service agent 12, the user is presented with a home page to launch a variety of operations and functions using one or more webpages or app screens, menus, and features to facilitate the service transaction between the users. FIG. 6 illustrates users 26 in communication with service agent 12 on electronic service platform 28 by electronic network 40 using devices 76 to access home webpage or app screen 130 with functions of request service 132, respond to request for service 134, accept service provider 136, pay service provider 138, feedback for service provider 140, feedback for service requester 142, and preferred service provider 144.

In a first example, service requester 16 selects request service 132 to post a request for service. The request for service can be for transportation, child care, pet sitting, dog walking, grocery shopping, home organization, housekeeping, errands, senior assistance, general helper, personal assistant, data entry, just to name a few. Request service 132 can be realtime and on demand, or scheduled for a later time.

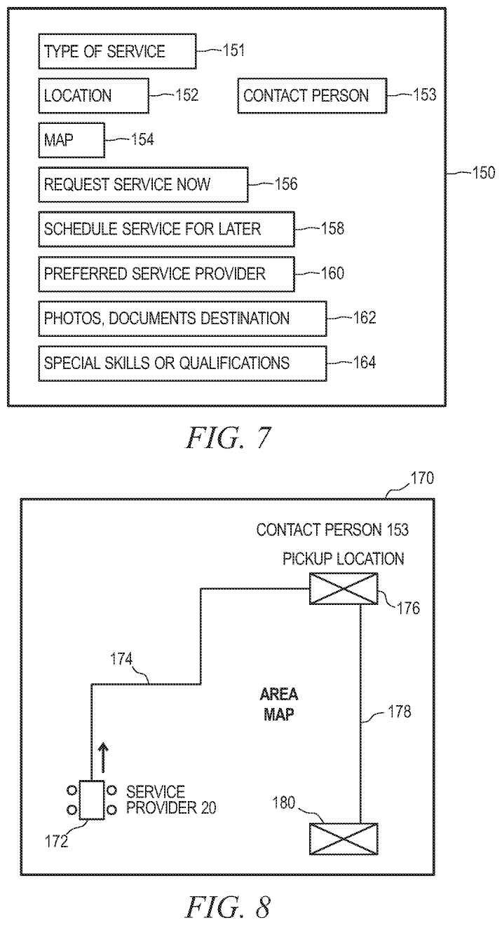

Webpage or app screen 150 in FIG. 7 shows further detail of entering a specific request for service. Webpage or app screen 150 allows service requester 16 to specify a type of service in block 151, and location of service in block 152, and contact person or person needing service in block 153. A map of the location is shown in block 154. Service requester 16 can request service now in block 156, or schedule the service for later in block 158. Service requester 16 can request a preferred service provider in block 160. Compensation is typically a fixed amount per time period, e.g., $/hour plus tip. Other forms of compensation can be used, e.g., security, property, service, barter, or any other form of value or quid-pro-quo. Service requester 16 can upload photos, destination, diagrams, or other documents relevant to the request for service in block 162. Service requester 16 can specify particular or special skills or qualifications in block 164.

In one example, service requester 16 enters a request for transportation to medical appointment for a senior from a given location. A photo of the senior is provided in block 153 or block 162. The service provider should have an automobile, insurance coverage, a valid driver's license, strength to assist the senior, and basic medical training, as per block 164. Service requester 16 provides the pickup location 152 and contact person 153, as shown on map 154, and selects request service now 156. Electronic service agent 12 identifies the nearest service provider to location 152 matching the service request. FIG. 8 illustrates webpage or app screen 170 with service provider 20 matching the service request immediately dispatched to pickup location 176 from block 152. Service provider 20 is shown with name, photo, contact information, and estimated time of arrival driving automobile 172 along route 174 to pickup location 176. The position of automobile 172 along route 174 is updated in realtime to show progress to the destination. Alternatively, service requester 16 can schedule a pickup date and time in block 158. Service requester 16 can track the transportation from pickup location 176 along route 178 to destination 180.

In another example, service requester 16 enters a request for a general helper for yard care at given location. The service provider should have a pickup truck, workers compensation waiver, and skills with power tools, as per block 164. Service requester 16 provides the pickup location 152 and contact person 153, as shown on map 154, and selects request service now 156. Electronic service agent 12 identifies the nearest service provider to location 152 matching the service request.

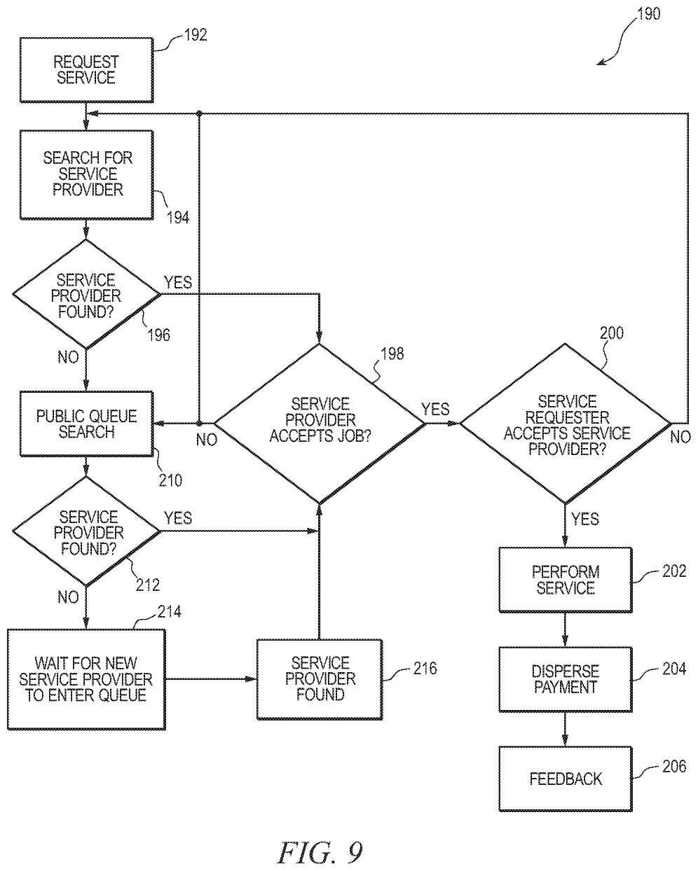

FIG. 9 illustrates a more detailed process flow of electronic service transaction 190 on electronic service platform 28 using data records in data structure 30. Service requester 16-18 posts service request 132 represented by request service block 192. Electronic service agent 12 identifies service providers 20-22 with skills, expertise, or experience relevant to service request 132, as provided during registration in blocks 102-122, or identified by other service transactions. Electronic service agent 12 searches for service providers in block 194 having the requisite skills and experience for request service 132. In some cases, electronic service agent 12 forwards request service 132 directly to service providers 20-22 known to have the requisite skills and experience. Electronic service agent 12 may also send request service 132 to unregistered users and other users who might still have the requisite skills, expertise, or experience for the service request. If a service provider is found in block 196, the service provider is given the option to accept or reject the job in block 198. If the service provider accepts the job in block 198, service requester 16 is given the option to accept or reject the service provider block 200. More than one service provider may be found and forwarded to service requester 16-18. Corresponding records are created in data structure 30, e.g., see service response 40-42. If service requester 16 accepts the service provider in block 200, the service is performed in block 202, payment is disbursed in block 204 ($/hour plus tip), and feedback is provided in block 206. If service requester 16 rejects the service provider in block 200, the search is repeated in block 194. If the service provider rejects the job in block 198, electronic service agent 12 either repeats the search in block 194 or conducts a public queue search in block 210 to expand the search to additional resources. If a service provider is found in block 212 following the public queue search, the service provider is given the option to accept or reject the job in block 198, as described above. If a service provider is not found in block 212 following the public queue search, electronic service agent 12 waits for a new service provider to enter the queue in block 214. Once a service provider is found in block 216, the service provider is given the option to accept or reject the job in block 198, as described above. Corresponding records are created in data structure 30.

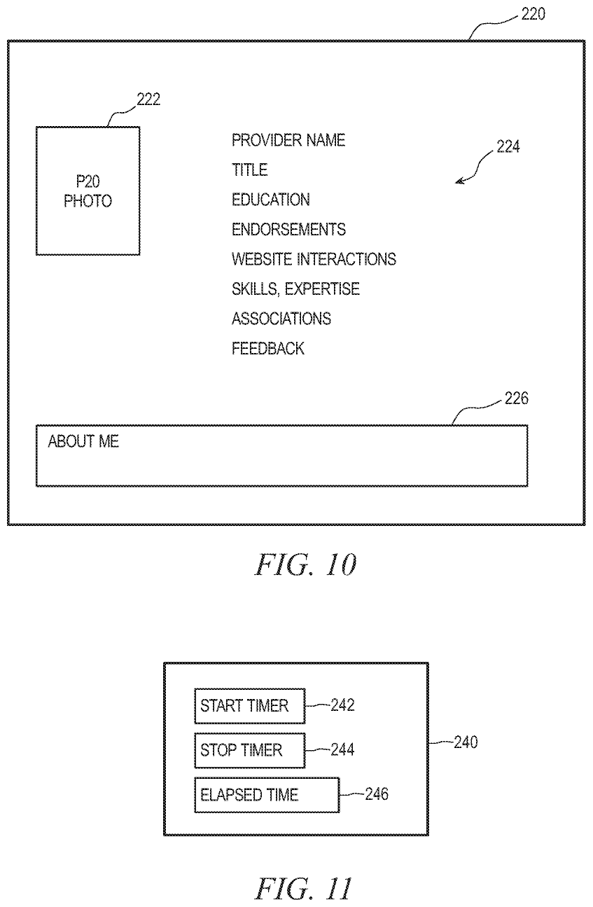

Returning to FIG. 6, service provider 20-22 would select respond to request for service 134 to accept or reject the service request as in block 198 of FIG. 9. Corresponding records are created in data structure 30, e.g., see service response 40-42. A profile of service provider 20 (P20) is available on webpage or app screen 220 in FIG. 10, including P20 photo 222 and relevant information 224 related to his or her skills, experience, and expertise. Service provider information 224 includes title, education, endorsements, website interactions, skills, expertise, associations, and feedback. About me block 226 allows service provider 20 to expand on or explain relevant information. Webpage or app screen 220 is useful for service requester 16-18 to evaluate and decide to enter into service transaction 190 with service provider 20. Service requester 16-18 would select accept service provider 136 to accept or reject the service provider as in block 200 of FIG. 9. Service provider 20-22 performs the service as in block 202 of FIG. 9.

In FIG. 11, electronic service agent 12 provides a timer in the webpage or app screen 240 to keep track of time of service for payment. Start timer 242 starts the clock, stop timer 244 stops the clock, and elapsed time 246 shows duration of the service. Service requester 16-18 would pay the service provider in block 138. Service requester 16-18 would rate or provide feedback for the service provider in block 140. Likewise, service provider 20-22 would rate or provide feedback for the service requester in block 142.

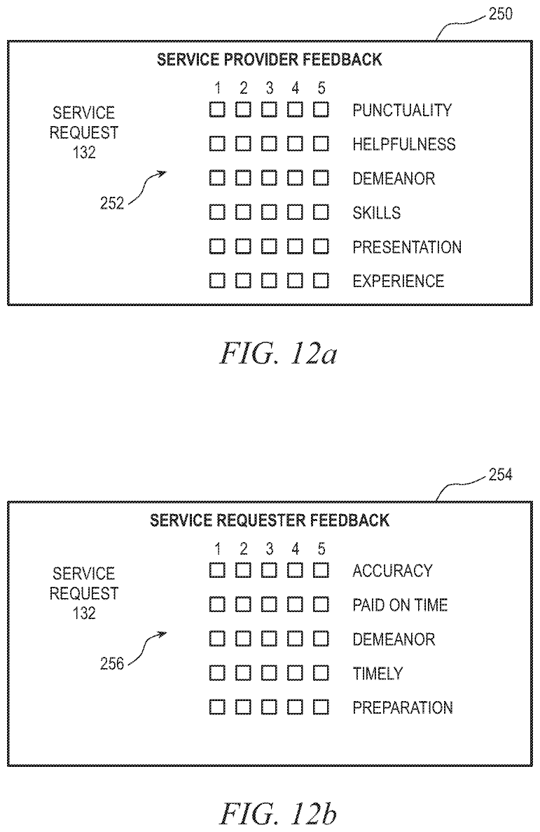

FIG. 12a shows webpage or app screen 250 for service requester 16-18 to provide feedback 252 with respect to service providers 20-22 following service transaction 190. There are varying degrees of acceptance, ranging from marginally acceptable to outstanding in punctuality, demeaner, helpfulness, skills, etc. For example, the service provider and service in response to service request 132 is rated on punctuality, helpfulness, demeaner, skills, presentation, and experience using a scale from 1-5 (1=lowest, 5=highest). FIG. 12b shows webpage or app screen 254 for service provider 20-22 to provide feedback 256 with respect to service requester 16-18 following service transaction 190. For example, the service requester in service request 132 is rated on accuracy, paid on time, demeaner, timeliness, and preparation using a scale from 1-5 (1=lowest, 5=highest). Feedback 252 and 256 are stored in database 14 and made available to service providers 20-22, as well as service requesters 16-18, as a way of gauging prior services in consideration of future transactions. A service provider or service requester that regularly exposes himself or herself to feedback and thrives is worthy of a high feedback rating, which will garner more confidence, respect, and willingness of the other party to do repeat service transactions. A service provider or service requester with low feedback ratings will naturally fade from electronic service platform 28 for the opposite reasons. Feedback 252 and 256 is an important measure of performance for optimal use and integrity of the system with accountability for all users 26.

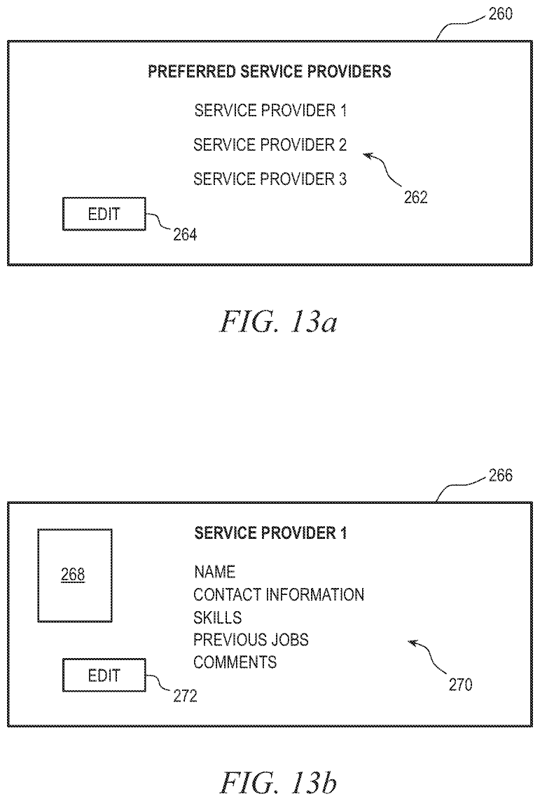

Returning to FIG. 6, service requester 16-18 maintain preferred service provider, as shown in webpage or app screen 260 of FIG. 13a. Service provider 1, service provider 2, and service provider 3 are the preferred service providers for service requester 16-18. FIG. 13b shows the listed preferred service providers 262 individually in webpage or app screen 266 with photo 268, as well as name, contact information, skills, previous jobs, and comments in area 270. Electronic service agent 12 may go to preferred service providers as a first option as they provide known service, continuity, and confidence of care. General register of service providers would be a second option if the preferred service providers were not available. Service requesters 16-18 can edit the preferred service providers in blocks 264 and 272.

The process of service transaction 190 using the organization of data structure 30 in database 14 simplifies the function and operation of computer system 10 by storing the service request and service response in an efficient manner, as well as facilitating the service transaction to maintain the quality, accuracy, integrity, and accountability within electronic service platform 28. The service request and service response format provide an organized, accurate, and efficient operation of computer system 10, as well as communication network 40. Electronic service agent 12 monitors and regulates the connection between users seeking to engage in a service transaction. Service requesters 16-18 ask direct and specific service requests. Service providers 20-22 have relevant skill and experience for the service. The service responses are compensated, with historical and objective feedback on individual responding users, so there is an expectation or accountability for true and accurate information.

Electronic service agent 12 operates in a peer-to-peer model providing on-demand realtime service for clients. The service can be request now, or scheduled for a later date and time. Electronic service agent 12 provides access to skilled, thoroughly vetted service professionals who are immediately available to provide specialized service or scheduled service.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling communication over an electronic network to facilitate a service transaction, comprising:
providing a database on a first computing system including a data structure to organize records for the service transaction;
posting a service request from a service requester on a second computing system to an electronic service agent on the first computing system;
searching for a service provider with capabilities to perform the service request conducted by the electronic service agent on the first computing system; and
forwarding the service provider to the service requester on the second computing system, wherein the service requester accepts the service provider for the service request.

2. The method of claim 1, wherein the service provider is a preferred service provider.

3. The method of claim 2, further including dispatching the preferred service provider after accepting the service provider.

4. The method of claim 1, further including providing feedback for the service provider.

5. The method of claim 1, further including providing feedback for the service requester.

6. The method of claim 1, further including tracking the service provider during the service transaction.

7. A method of controlling communication over an electronic network to facilitate a service transaction, comprising:
providing a database on a first computing system including a data structure to organize records for the service transaction;
posting a service request from a service requester on a second computing system to an electronic service agent on the first computing system; and
dispatching a service provider with capabilities to perform the service request by the electronic service agent from the first computing system, wherein the service provider performs the service transaction.

8. The method of claim 7, further including:
searching for a service provider with capabilities to perform the service request on the first computing system; and
forwarding the service provider to the service requester on the second computing system, wherein the service requester accepts the service provider for the service request.

9. The method of claim 7, wherein the service provider is a preferred service provider.

10. The method of claim 7, further including providing feedback for the service provider.

11. The method of claim 7, further including providing feedback for the service requester.

12. The method of claim 7, further including tracking the service provider during the service transaction.

13. The method of claim 7, further including compensating the service provider after performing the service transaction.

14. A non-transitory, tangible computer readable medium storing instructions for controlling communication over an electronic network, the instructions causing the electronic network to perform the steps, comprising:
providing a database on a first computing system including a data structure to organize records for the service transaction;
posting a service request from a service requester on a second computing system to an electronic service agent on the first computing system; and
dispatching a service provider with capabilities to perform the service request by the electronic service agent from the first computing system, wherein the service provider performs the service transaction.

15. The non-transitory, tangible computer readable medium of claim 14, further including:
searching for a service provider with capabilities to perform the service request on the first computing system; and
forwarding the service provider to the service requester on the second computing system, wherein the service requester accepts the service provider for the service request.

16. The non-transitory, tangible computer readable medium of claim 14, wherein the service provider is a preferred service provider.

17. The non-transitory, tangible computer readable medium of claim 14, further including providing feedback for the service provider.

18. The non-transitory, tangible computer readable medium of claim 14, further including providing feedback for the service requester.

19. The non-transitory, tangible computer readable medium of claim 14, further including tracking the service provider during the service transaction.

20. The non-transitory, tangible computer readable medium of claim 14, further including compensating the service provider after performing the service transaction.
